(19) United States
(12) Patent Application Publication
(10) Pub. No.: US 2010/0060553 A1
(43) Pub. Date: Mar. 11, 2010

(54) LED display utilizing freestanding epitaxial LEDs

(76) Inventors: Scott M. Zimmerman, Basking Ridge, NJ (US); Karl W. Beeson, Princeton, NJ (US); William R. Livesay, San Diego, CA (US)

Correspondence Address: Goldeneye Inc., Suite 233, 9747 Businesspark Avenue, San Diego, CA, 92131, US

(21) Appl. No.: 12/583,527

(22) Filed: Aug. 20, 2009

Related U.S. Application Data
(60) Provisional application No. 61/189,651, filed on Aug. 21, 2008.
(60) Provisional application No. 61/189,650, filed on Aug. 21, 2008.

(51) Int. Cl. G09G 3/28; G09G 3/34

(52) U.S. Cl. 345/60; 345/84

(57) ABSTRACT

High resolution light emitting diode (LED) displays can be formed from freestanding small epitaxial LED chips or small LED arrays. The addressing elements for the LED display can be active matrix backplane. The LED display may use isotropic and directional luminescent elements. The LED displays can be flat screen, fixed image, projection or low resolution or high resolution direct view. A macro freestanding epitaxial LED chip with multiple addressable pixels is described which forms a complete microdisplay.

### REFERENCE TO PRIOR APPLICATION

This application claims the benefit of U.S. Provisional Patent Application Ser. No. 61/189,651 and U.S. Provisional Patent Application Ser. No. 61/189,650, which are herein incorporated by reference.

### FIELD OF THE INVENTION

The present invention relates to display apparatuses such as a display having a plurality of light-emitting diodes (LEDs). More particularly, the invention relates to a high resolution multicolored LED flat panel display apparatus having a relatively simple structure which provides high brightness and high contrast, yet is inexpensive to manufacture.

### BACKGROUND OF THE INVENTION

Direct-view flat panel displays typically consist of a light source and a spatial modulator LCD. The light source constitutes a significant cost of the display.

The main cost in these types of displays remains the LCD panel itself. Due to the complexity of the LCD panel, multi-billion dollar manufacturing facilities are required to fabricate these large area LCD panels. Even with such a formidable infrastructure, display performance issues such as jitter, color gamut, and stability still exist. In addition, the life and durability of these displays are handicapped by the multiple elements required to form the display. For example the backlight has a limited life.

Emissive display approaches such as plasma (PDP) and secondary emission displays (SEDs) all offer some benefits versus LCD but suffer from the need for an evacuated cavity and life issues associated with high energy electrons bombarding the luminescent materials (light emissive layer, e.g. phosphor).

Displays for large venues eliminate the spatial light modulator by utilizing arrays of addressable discrete LEDs exhibiting sufficient output to create large area images. These large area digital displays are quite expensive requiring hundreds of thousands of discrete LEDs and high electrical power to drive them. Discrete LEDs are bulky requiring mounting means and interconnection means to address each LED. This has limited their use to large LED displays.

Many have sought a more efficient means of addressing and powering LEDs to be used in smaller displays. For example, U.S. Pat. No. 4,445,132, to Ichikawa et al. describes a display fabricated with a matrix of LEDs. However, this still required complex (expensive) means to connect and address the LEDs.

With the aforementioned drawbacks to LED displays, the industry has sought means to fabricate smaller arrays of LEDs with limited success. U.S. Pat. No. 6,087,680 to Gramann et al. describes a method to sandwich LEDs between a matrix of transparent electrodes to permit use of smaller LEDs in construction of a display. However, this requires tedious alignment of the LEDs to printed rows and columns of electrodes, which complicates the manufacturing process. This, combined with expensive processing steps (e.g. MOCVD) to fabricate inorganic LEDs, makes a direct view display prohibitively expensive using arrays of inorganic LEDs.

To overcome these obstacles, active matrix organic LEDs (AMOLEDs) have been promoted as a low cost means to fabricate arrays of organic LEDs into direct view flat panel displays to compete with popular LCD and emissive (PDP) displays. However, the moisture sensitivity of the organic materials used for OLED displays has required a sealed cavity similar to plasma displays to achieve adequate lifetimes. This has negated one of the purported advantages (low cost) of these displays.

Therefore, there is a need for an emissive display technology, which is economical, robust and scalable to large formats. Further, there is a need for a simple and inexpensive method for creating an addressable array of LEDs scalable up to virtually any size, thus eliminating the need for a light valve (LCD panel). In addition, there is a need for an emissive display, which does not require a sealed cavity as required in plasma, SED, and OLED displays.

Nitride based LEDs are being used in an increasing number of lighting applications. One of the preferred methods of manufacture is based on liftoff of the epitaxial layer from a seed or growth substrate such as sapphire. This is typically done after a wafer bonding step to a secondary substrate such as silicon, germanium, or some other CTE (coefficient of thermal expansion) matched layer which supports the epitaxial layer and prevents cracking and damage to the active epitaxial LED layer. This increases the cost of manufacturing LEDs and also limits the physical size of the LED. These factors make it difficult and expensive to form small pixel high resolution displays using miniature LEDs as the emissive pixel.

One of the main attractions of Organic Light Emitting diodes (OLED) displays is the promise of low cost manufacturing made possible by being able to print the organic LEDs directly on a display panel. However, the inherent nature of organic materials and their interaction with each other and the environment has forced manufacturers to use exotic encapsulation techniques with its associated cost penalties. Even using glass panels to encapsulate and protect the organic LEDs from the environment has not met with unqualified success as OLED displays have been plagued with short lifetimes. Inorganic LEDs, as contrasted with organic LEDs, have exhibited long lifetimes and are inherently environmentally stable. Therefore, there is a need for a robust printable inorganic LED which can be manufactured at low cost, is environmentally stable, and does not require precise alignment to an addressing matrix or grid of electrodes.

Various attempts have been made to create a composite inorganic LED structure based on semiconducting particles embedded within a dielectric matrix, such as U.S. Pat. No. 4,136,435 to Li. This approach depends on connecting pieces of p and n doped materials within a composite to form the active region of the device. This approach limits the efficiency of such a device.

More recently, U.S. Pat. No. 6,683,416 to Oohata et al. has worked on various transfer and handling methods for spatially positioning small LED die for display applications. These, amongst other approaches, use various means to spatially expand the LEDs from a typically 2 inch wafer to a full sized display. This typically is done by stretched films or other means. These approaches, however, depend on maintaining the position of the die relative to each other.

Unlike organic LEDs, inorganic LEDs are environmentally robust. However, they are typically made via semiconductor wafer processing which is difficult to scale to large formats. Sliced, diced, and packaged inorganic LEDs have been assembled into large area displays, however, the cost and complexity of such displays have limited this type of display to very large commercial applications. Therefore, there is a need for an inorganic LED that can be fabricated inexpensively, printed onto plastic or glass panels, does not require expensive supporting substrates to achieve mechanical robustness, and does not require precise alignment to an active matrix or row and column electrode structure

It is accordingly an object of the invention to provide an LED display which overcomes the aforementioned disadvantages of LED based displays and in which the size of the inorganic LED chips is reduced and in which the LEDs may be manufactured economically and easily dispersed without requiring alignment to a grid to form an addressable display and be resistant to environmental conditions (moisture, etc.) thereby forming a high brightness flat panel display without the need of a light valve (LCD etc.).

### SUMMARY OF THE INVENTION

With the foregoing and other objects in view there is provided in accordance with the invention, an LED display and method of making the same that overcomes the deficiencies and high cost of fabrication of prior art displays cited above. It is an object of this invention to overcome the aforementioned limitations of a printable LED display by incorporating novel inorganic epilayer LED chips or flakes (FLEDs) into a binder and printing them with various wavelength conversion materials. More specifically, the invention utilizes epilayer (laser lifted off) derived LED flakes or flake LEDs (FLEDs). The method and process for making these self-standing epilayer chip (Epichip) flake LEDs (FLEDs) is described in a co-pending U.S. patent application Ser. No. 12/148,894, commonly assigned as the present patent application and herein incorporated by reference. In a co-pending application U.S. patent application Ser. No. 12/380,439, commonly assigned as the present patent application and herein incorporated by reference, a method of making an inexpensive LED backlight with sufficient light for backlighting large area LCD panels is described. In another U.S. Provisional Patent Application Ser. No. 61/067,934, commonly assigned as the present patent application and herein incorporated by reference, a method and process is described to form these FLEDs or Epichips into a broad area flat panel light source. The methods described in those Applications are hereby incorporated into this application by reference. The methods shown in U.S. Provisional Patent Application Ser. No. 61/067,934, in fabricating large area light panels can be combined with the methods and processes of the present invention to form addressable large area displays. Additional methods to fabricate the EpiChips used in this invention are described in U.S. Provisional Patent Application Ser. No. 61/208,455, commonly assigned as the present patent application and herein incorporated by reference.

These substrate-less all Gallium nitride LEDs are referred to as freestanding GaN, FLEDs, epitaxial LEDs or Epichips.

In this invention, these FLEDs construct an XY addressable active LED display. Each pixel of the display is formed by one or more FLEDs, thereby unlike an LCD display, the display does not require a backlight. In U.S. patent application Ser. No. 12/148,894, methods are shown that incorporate several proprietary processing steps to produce free standing epi LED chips or flake LEDs (FLEDs) that do not require a secondary substrate. These FLEDs or epi chips can be arrayed in one, two, and three dimensional planes such that an emissive display is formed. Unlike other display technologies, these FLEDs do not require a sealed cavity and can be matrix addressed in a number of different ways.

While visible emission is possible with the FLEDs, the preferred embodiment for this invention is UV emitting FLEDs with a peak emission wavelength less than 450 nm. In one embodiment of this invention, wavelength conversion materials are used to create the visible emission required. This eliminates the need for increased drive complexity as required when multiple emission wavelength LEDs are used. It also allows for the addition of other colors via additional luminescent materials.

In another embodiment of this invention, a series of linear LED arrays are assembled onto an addressing means such that at least one TV line is created. These linear arrays are then stacked in a manner to create at least a 2 dimensional array that constitutes the display. Both direct addressing and active addressing schemes are embodiments of this invention. More specifically, the use of an active addressing scheme as used in cell phone LCD displays or STN displays is a preferred embodiment reducing the interconnects required. The non-linear characteristics of the LEDs themselves facilitates the use of this addressing means. Various drive means, including but not limited to direct drive, capacitive and inductive coupling, and AC drive means, as known in the art, are embodiments of this invention. The use of printable electronics technology, including the creation of active and passive electrical elements, to drive the LEDs is also an embodiment of this invention.

Another embodiment of this invention is the shaping of the individual LED chips (FLEDs) such that directivity is imparted to the individual chips themselves as well as the use of micro-optical elements over the individual chips. Further still the use of wavelength conversion means, including but not limited to phosphor powders, phosphor flakes, monocrystalline luminescent materials, and quantum confined wavelength conversion materials, are also embodiments of this invention. The use of light absorbing layers to further enhance the display contrast is also part of this invention. The means and methods used to fabricate these layers are further embodiments of this invention.

While the preferred embodiment for the epi chip due to cost and simplicity is a vertical structure, alternate structures, including but not limited to flip chip, side contacts, super-luminescent, edge emitting LEDs, and various laser diodes both vertical cavity as well as edge emitting structures are embodiments of this invention. For example, a method of forming side contacts and array addressable structures in LEDs is shown. These arrays are based on light emission normal to the plane of the wafer containing a side contact configuration and a separate addressing means incorporated into an integrated circuit backplane attached via the wafer bonding step. However, in this invention no wafer bonding step is required as the FLEDs are self-standing and are applied by screen printing, inkjet printing, etc., for example, to an active matrix backplane.

As practiced in this invention, a single 2 inch wafer of UV emitting LEDs is capable of generating over 100 optical watts based on two thousand one millimeter square die each outputting 50 mW of UV. A typical large area display requires less than 10 optical watts of output to generate a display with 100 ftL brightness. Based on this, a die area less than 100 microns square is needed per pixel. With prior art methods of fabricating LEDs, formation of small LEDs of less than 100 microns is costly and difficult to form robust die.

By using HVPE deposition processes, thick epitaxial layers (greater than 5 microns) can be grown economically. These thicker layers allow for the fabrication of mechanically robust FLEDs as the chip area (more preferably greater than 1 square micron and less than 1000 square microns). These thicker chips can be used in manner similar to the spacers presently used in LCD displays to set the gap between two glass layers. The increased thickness allows for the creation of nearly cubical FLEDs, which are robust enough for dispensing and other transfer means. Several methods of orientation are disclosed.

The incorporation of the FLEDs into solvent based dispersions allows for orientation based on geometry. In this approach, FLEDs in which the thickness dimension is less than the side dimension are used. These flake like FLEDs preferentially orient such that the large surface area is parallel to the substrate due to surface tension effects as the solvent evaporates. If the FLED has a solder coated or solderable contact on one side, a solder/solderable coating on the substrate can be used to selectively attach FLEDs which are only oriented in one direction. Conversely, if a non-selective means is used, the FLEDS can be driven using AC drive approaches with the FLEDs arranged in antiparallel means. The large number of die possible using this approach creates an averaging effect.

Alternately, dispersion of the LEDs may use a sedimentation approach, similar to how phosphors are deposited within CRT glass tubes. In this case, the substrate is submerged within a liquid buffer such as water. The FLEDs are dispersed on the surface of the water and allowed to settle onto the submerged substrate. Orientation is possible by taking advantage of the density difference between the metal contact (typically gold 19.3 g/cc) and the GaN (typically 6.1 g/cc). As the FLEDs sink down to the substrate, the higher density side is oriented towards the substrate in the same manner as a weighted keel on a boat. This approach allows for the use of cubical and even column like FLEDs to be deposited. Antiparallel orientations are also permitted based on this method.

The invention also incorporates alternative methods to orient the FLEDs including shearing movements. For example, the application of pressure is used to orient the FLEDs into place. This may be via a lateral movement, pressing action, combination of both, and/or vibrational means such as ultrasonic.

A variety of contact means are disclosed, including but not limited to, anisotropic adhesives containing spherical, flake, and rod like conductive particles. More particularly, the use of carbon nanotubes within an organic or inorganic binder is disclosed as a means of providing a contact to the FLEDs either to the p, n, or both n and p (AC drive conditions) contacts. Even more particularly, the use of a contact means significantly thinner than the FLEDs thickness is an embodiment of the invention. The thicker FLED allows for the use of manufacturable coating thickness without the fear of shorting around the FLED junction. The incorporation of luminescent materials within the contact forming material and the spatial patterning of these materials to form various color pixels for a display are also disclosed. The use of a passivation layer on the edge of the FLED formed during fabrication of the FLED to further prevent shorting issues is also disclosed in this invention.

The FLED may contain one or more of the following elements to enhance orientation and/or performance. Solder coating on at least one surface, ODR reflector (including the use of carbon nanotubes to create microcontacts between the p layer of the device and reflector), photonic crystal elements, micro-optical structures, surface coatings to inhibit solderability both on sides and at least one surface, and luminescent elements.

This invention creates a printable composite material, containing flake like microchips of inorganic UV LEDs (FUVLEDs). In this manner, low cost printable large area flat panel displays can be constructed.

The development of a low cost method of forming freestanding epitaxial chips enables a variety of LED display based products. Using this method, both micron sized epitaxial chips and centimeter sized LED arrays can be constructed. The ability to process these epitaxial chips at elevated temperatures enables the use of a variety of processes for packaging and device formation.

This invention creates microdisplays where multiple pixels are formed in the freestanding GaN epichip with interconnects and optical elements on each LED such that a line or microdisplay may be formed. The unique nature of the substrate less LED enables these novel LED arrays and displays to be formed inexpensively and with high efficiency.

### BRIEF DESCRIPTION OF THE DRAWINGS

FIGS. 1A, 1B and 1C depict an epitaxial chip of the present invention.

FIGS. 2A and 2B depict an epitaxial chip with a high aspect ratio of the present invention.

FIG. 3 depicts an epitaxial chip with an additional addressing element on the chip itself of the present invention.

FIGS. 4A and 4B depict an assemblage of epitaxial chips vertically and horizontally oriented of the present invention.

FIG. 5 depicts a linear array of horizontally oriented epitaxial chips of the present invention.

FIG. 6 depicts an example addressing circuit built on the epitaxial chips of the present invention.

FIGS. 7A, 7B and 7C depict various interconnect means to the assemblage of epitaxial chips which take advantage of their aspect ratio.

FIG. 8 depicts a macro epitaxial chip with integral optical element of the present invention.

FIGS. 9A and 9B depict a macro epitaxial chip with integral optical element and various interconnect means of the present invention.

FIG. 10 depicts a macro epitaxial chip with at least one directional luminescent element of the present invention.

FIG. 11 depicts an assemblage of epitaxial chips formed into a sheet with interconnect and at least one luminescent element of the present invention.

FIG. 12 depicts an assemblage of epitaxial chips with active addressing elements formed into a sheet and at least one luminescent element of the present invention.

FIG. 13 depicts an assemblage of epitaxial chips deposited onto an addressing plane of the present invention.

FIGS. 14A and 14B depict a macro epitaxial chip used in a projector and a 3 chip version with an Xcube combiner used in a projector of the present invention.

FIG. 15 depicts a self assembly process for locating the epitaxial chips onto an addressing plane of the present invention.

FIG. 16 depicts a process forming a glass composite sheet containing epitaxial chips of the present invention.

FIG. 17 depicts a display consisting of a glass composite sheet containing epitaxial chips, addressing means, and wavelength conversion elements of the present invention.

FIG. 18 depicts an adaptive backlight or large area segmented light source arranged in blocks wherein the block consist of at least one LED and multiple wavelength conversion chips of the present invention.

FIGS. 19A and 19B depict a polarization extraction element and associated waveguide of the present invention.

### DETAILED DESCRIPTION OF THE INVENTION

The LED addressable display is based on a freestanding epitaxial LED chip (Epichip). One method to fabricate these unique LEDs utilizes growing thick (10-100 micron) doped GaN on sapphire via HVPE, then growing PN junction & multiple quantum wells by MOCVD.

A method for fabricating mechanically robust, self-standing epitaxial layer LEDs is shown in U.S. patent application Ser. No. 12/148,894, commonly assigned as the present application and herein incorporated by reference. This process is modified slightly to fabricate LEDs for a printable display. A process for fabricating ultra thin epitaxial layer chips is described as follows: An epitaxial layer is first grown on a sapphire substrate to form a wafer. The epitaxial layer consists of an aluminum doped gallium nitride. The aluminum doped gallium nitride is grown in an epitaxial reactor using high vapor pressure epitaxy. A metal contact is deposited. This metal contact can be indium tin oxide, zinc oxide, carbon nanotube, or nickel gold. An ODR is deposited with the ODR tuned to the UV based on a low index dielectric like SiO2 with a dispersion of carbon nanotubes and a reflective metal coating. These metal and ODR contacts are typically deposited via evaporative or sputtering means. Typically, additional metallization is added by means such as, but not limited to, jet vapor spray, electroplating and electroless plating.

The wafer can be patterned to define the chip size or left un-patterned depending on the FLED desired. If the metallization is patterned, the wafer is ready for liftoff and the FLEDs are simply broken into pieces once the epitaxial layer is removed. This is possible because the epitaxial layer is brittle and can be easily fractured. In this case, the need for post etching to remove excess gallium created during the trenching operation is eliminated. If the metal is unpatterned, a protective coating is deposited over the entire wafer. This protective coating (which can be polyvinyl alcohol or a variety of resists as known in the art) protects the underlying epitaxial layer from the next process step, which is cutting laser trenches down to the sapphire using a DPSS laser system such as available from J. P. Sercel & Associates Model IX-200 or similar. The laser operates at 266 nm and can be configured to create a line beam with a very narrow width (less than 3 microns). The laser trenches are cut in a grid across the wafer in both directions. These define the sizes (width) of the epitaxial layers. For the illumination applications, epitaxial die sizes range from 10×10 microns to 10×10 mm. For the fabrication of a visual display, the epitaxial layers will have sizes ranging from 5-10 microns to 100 microns square.

After the laser trenching, the wafer is immersed in a variety of etching means, including, but not limited to, potassium hydroxide etching solution, plasma etching, and other means known in the art, and then rinsed in deionized water to remove the laser debris.

In the next step, a silicon dioxide layer is deposited. The protective coating is lifted off using a solvent for the protective coating. This also may require an e-beam exposure step to break the continuity of the SiO2 coating. The wafer is then placed back under the DPSS laser and the epitaxial layer microchips are lifted off by directing the laser through the sapphire layer to the interface bond line of the epitaxial layer and sapphire. Unlike other liftoff approaches, a very non-uniform beam profile is used. Typically a 2 to 3 micron wide, 100 to 1 mm long, line source is generated with gaussion distributions in both axes. The pulses are scanned such that a narrow strip of isolated trenches are cut into the epitaxial layer. Because the epitaxial layer is thicker than the spacing between pulses, both the separation and the formation of extraction elements can be done within a single operation. This approach is much more gentle than conventional liftoff approach based on excimer processing. This combined with low stress thick epi design eliminates the need for wafer bonding. The resulting chips contain extraction elements formed based on the direction, spacing and number of passes used during the separation process.

A more preferable process for fabricating freestanding substrate less epichips is shown in U.S. Provisional Patent Application Ser. No. 61/188/115, commonly assigned as the present application and herein incorporated by reference. This process utilizes freestanding GaN foils to grow high performance LEDs at low cost. Both of the aforementioned processes can be utilized to fabricate the LED structures and displays disclosed herein.

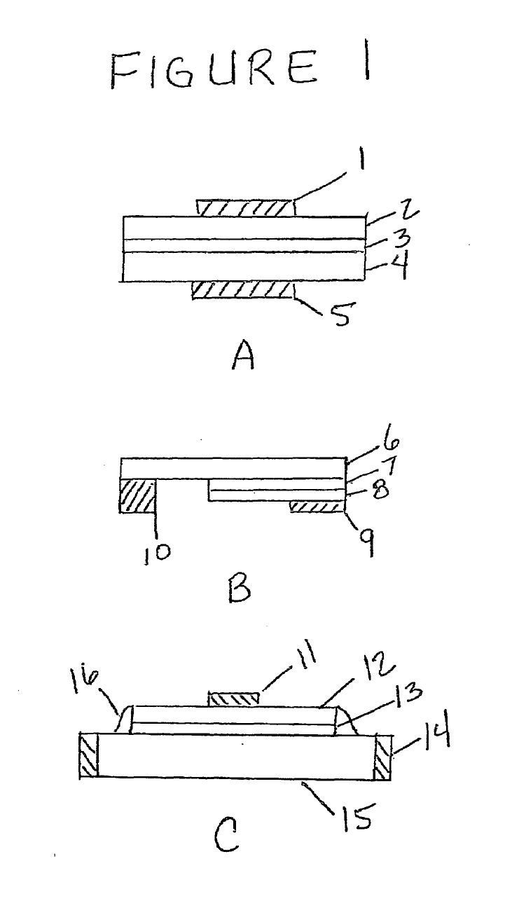

FIG. 1 depicts three different types of epitaxial chips.

In FIG. 1A, a top contact 1, p conductivity doped semiconductor layer 2, an active region 3, n conductivity doped semiconductor layer 4 and a bottom contact 5 form a vertical LED structure device. The use of current spreading layers (not shown in this Figure) as known in the art improves ohmic contact between p layer 2 and top contact 1 or improves ohmic contact between n layer 4 and bottom contact 5. Most preferably, electron beam curing can cure spin-on transparent oxides or improve the properties of transparent oxides. The active region 3 may consist of, but is not limited to, single heterojunctions, double heterojunctions, MQWs, SQWs, and quantum dot layers, as known in the art. The semiconducting portions of this device of p layer 2, active region 3, and n layer 4 may consist of, but is not limited to, nitrides and oxides. More preferably, they consist of at least one of the following: GaN, AlGaN, InGaN, AlInGaN, InN, AlN, ZnO, ZnMgO, diamond, BN, and InGaNP. The thickness to width ratio is between 100 and 0.001 with a ration between 100 to 1 most preferred.

In FIG. 1B, a coplanar or flipchip configuration for the LED structure device is shown. In this arrangement, the semiconductor structure is formed from a first doped layer 6, an active region 7 and a second doped layer 8. A mesa is formed isolating the active region 7 and the second doped layer 8 from a first contact 10 on the lower surface of the first doped layer 6. A second contact 9 is formed on the lower surface of the second doped layer 8. Doped layers 6 and 8 have opposite conductivity types either n or p. The use of reflective means on the lower surface of the second doped layer 8 or on the upper surface of the first doped layer 6 provides directionality for light emission as known in the art. The use of extraction elements on the lower surface of the second doped layer 8 or on the upper surface of the first doped layer 6 enhances extraction efficiency.

In FIG. 1C, a side contact epitaxial chip is shown. This differs from FIG. 1A in that side contacts 14 are substantially attached to the edge of doped layer 15. While layer 15 is typically n type conductivity, due to improved optical characteristics, p type conductivity is also an alternative. A passivation layer 16 protects active region 13. Optionally, electron beam curing may be used to enhance the environmental and mechanical characteristics of layer 16, particularly using large area electron beam sources. Even more preferably, electron beam curing can be used within a controlled atmosphere and at an elevated temperature. The use of this process can also modify the hydrogen incorporation in the active region 13 and/or other layers. Electron beam irradiation improves the ohmic contact between the contact 11 and/or 14 and their respective layers 12 and 15. Most preferably side contact epitaxial chips can be formed in which the polarity is reverse such that anti-parallel interconnect is facilitated. An example of a side contact arrangement on an LED is shown in US-2006-0284190-A1.

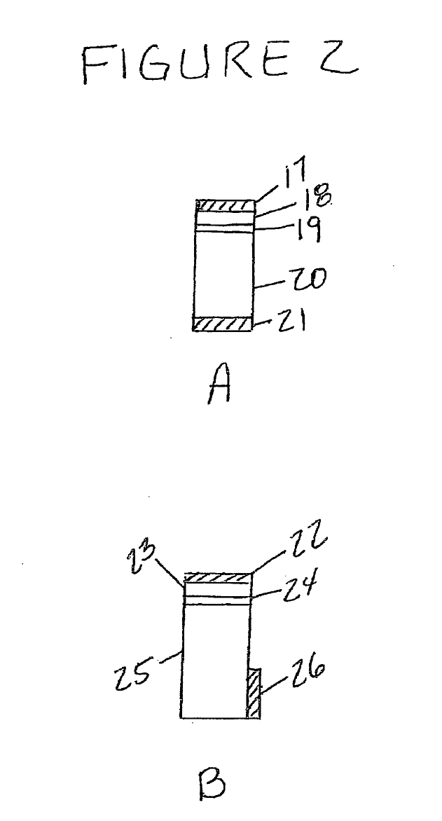

FIG. 2 depicts a high aspect ratio epitaxial LED chip where the thickness to width ratio is greater than 1. Epitaxial chips of this type may be formed by a variety of methods including but not limited to etching, laser scribing, and mechanical means. This aspect ratio facilitates alignment and interconnection. The device in FIG. 2A consists of top contact 17, p layer 18, active region 19, n layer 20 and bottom contact 21. The device in 2B consists of top contact 22, p layer 23, active region 24, n layer 25 and side contact 26. Preferably the overall thickness of the device is greater than 5 micron. More preferably the overall thickness is greater than 20 microns. For macro epitaxial chips which include optical elements, the ratio of thickness to individual optical element greater than 1 is preferred. The use of low absorption crystal growth via HVPE methods is a preferred method of producing at least one of the layers described in this present invention.

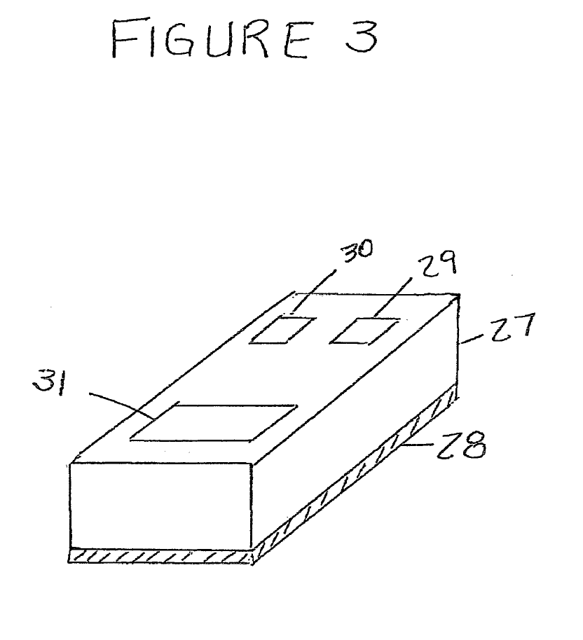

FIG. 3 depicts an epitaxial LED chip on which additional electrical devices 31, 30, and 29 have been attached or grown. These additional electrical devices may consist of, but are not limited to, capacitors, inductors, transistors, diodes, fets, or other semiconducting elements. Methods of fabricating these elements on freestanding Nitride layers are shown in US-2009-0059586-A1, commonly assigned as the present application and herein incorporated by reference.

The inclusion of interconnect via metal layers or transparent oxides is also an embodiment of this invention. The added functionality can be used for, but is not limited to, addressing, output monitoring, power conditioning, power conversion, color tuning, or charge storage. These additional electrical devices more preferably are grown epitaxially at the wafer level taking advantage of the crystal quality of the epitaxial layer and may consist of oxides, nitrides, silicon, germanium, or other semiconducting materials as known in the art. Alternately, the attachment of chips that contain semiconducting devices can be accomplished by waferbonding, die attach, flip chip mounting, or gluing to any of the surfaces of epitaxial chip body 27. The use of a reflective contact 28 as known in the art is also an embodiment of this invention including the use of eutectic solders as a die attach means. Higher temperature eutectic or attachment means can be used for additional electrical devices 31, 30, and 29 than the eutectic or attachment means used on reflective contact 28.

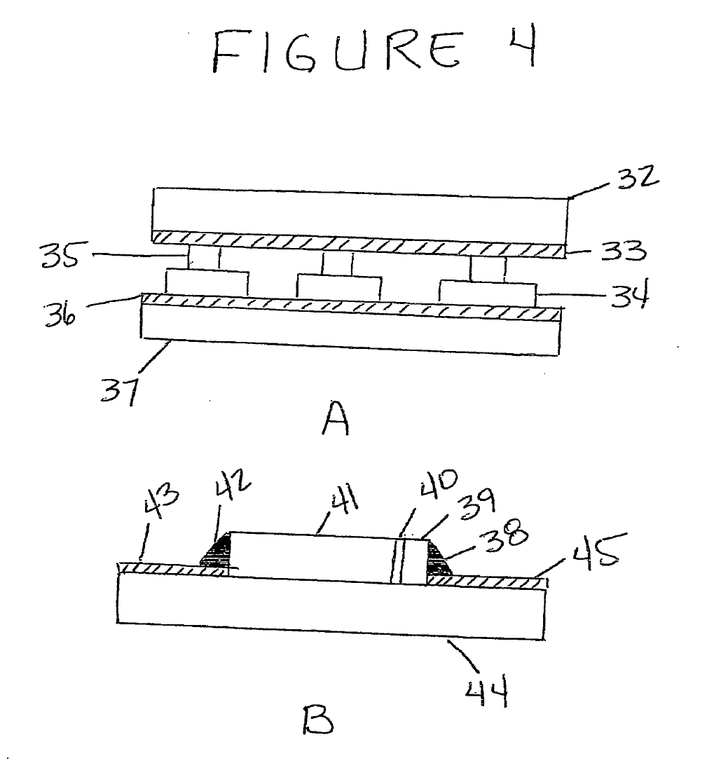

FIG. 4 depicts epitaxial LED chips mounted in both vertical and horizontal positions.

FIG. 4A depicts the use of a vertical LED device. In this case, the device has a top connection 35 and bottom connection 34. Interconnect means 33 and 36 respectively, provide connection to the epitaxial chips 32 and 37 through their associated connections. This sandwiched approach is useful for encapsulated sources and substrates 32 and 37 may provide thermal conduction for the devices. Using this approach, isotropic emitters are possible when the interconnect means 33 and 36 are transparent conductive oxides (for example ZnO, ITO, etc.).

FIG. 4B depicts an alternate mounting, which is a horizontal LED device. In this case, a high aspect epitaxial chip consisting of a p layer 39, an active region 40 and a n layer 41. Contact is made by contact means as known in the art, typically metal contacts forming good ohmic contact with the p layer 39 and n layer 41. The aspect ratio of the epitaxial chip can enhance alignment. Centering techniques such as solder surface tension by attachment means 38 and 42 can also be used. Alternately, conductive materials can be used, including, but not limited to, conductive inks, conductive epoxies, printable conductive materials and mechanical contacts for attachment means 38 and 42. The multiple epitaxial chips can be connected by interconnects 45 and 43. The substrate 44 may be a dielectric, coated metal, metal, or ceramic material. The use of underfills and overfills protects, isolates, cools, or supports the epitaxial chips by substrate 44. The use of this approach enables testing and repair of epitaxial chips especially in arrays. Even more preferably, the use of epitaxial chips in which the thickness to width ratio is greater than 1 increases emitting surface area. The formation of optical elements including, but not limited to, lens, gratings, reflective polarizers, black matrices, filters (both absorptive and dichroic), photonic crystals, and luminescent elements, to modify wavelength, polarization, directivity, and contrast are embodiments of this invention.

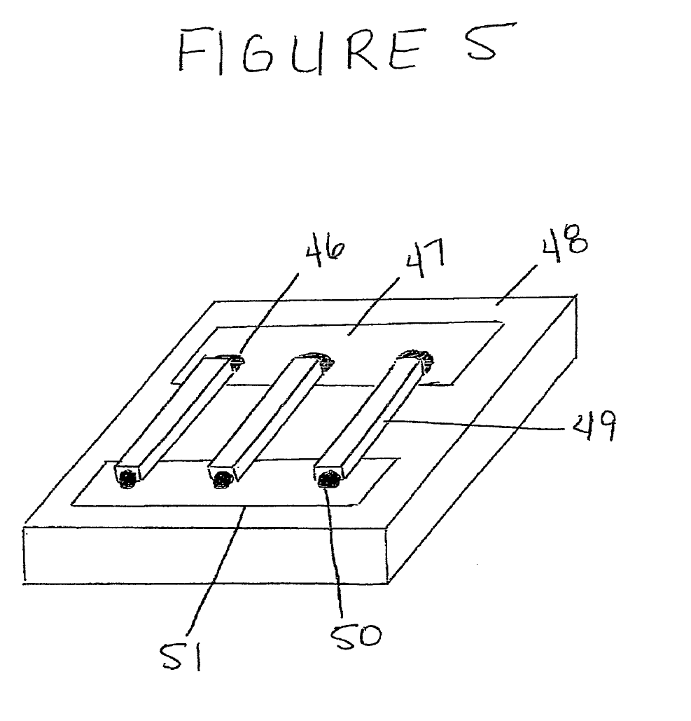

FIG. 5 depicts a linear array of horizontally oriented epitaxial chips 49. The epitaxial chips 49 are attached to interconnects 51 and 47 by attachments means 50 and 46 as discussed in the previous figures. Substrate 48 may contain multiple arrays for ease in testing and handling and be subsequently diced via laser, mechanical, or etching means.

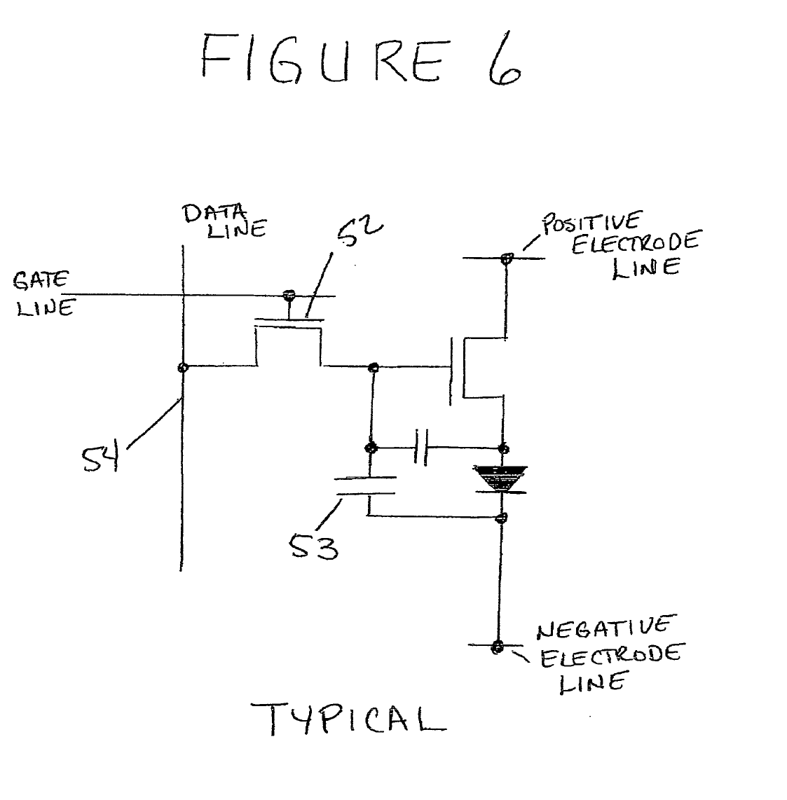

FIG. 6 depicts a typical active addressing schematic as used in LCD and OLED applications. The formation or attachment of interconnect 54, passive element 53, and/or active elements 52 on the epitaxial chip at wafer level or chip level is an embodiment of this invention.

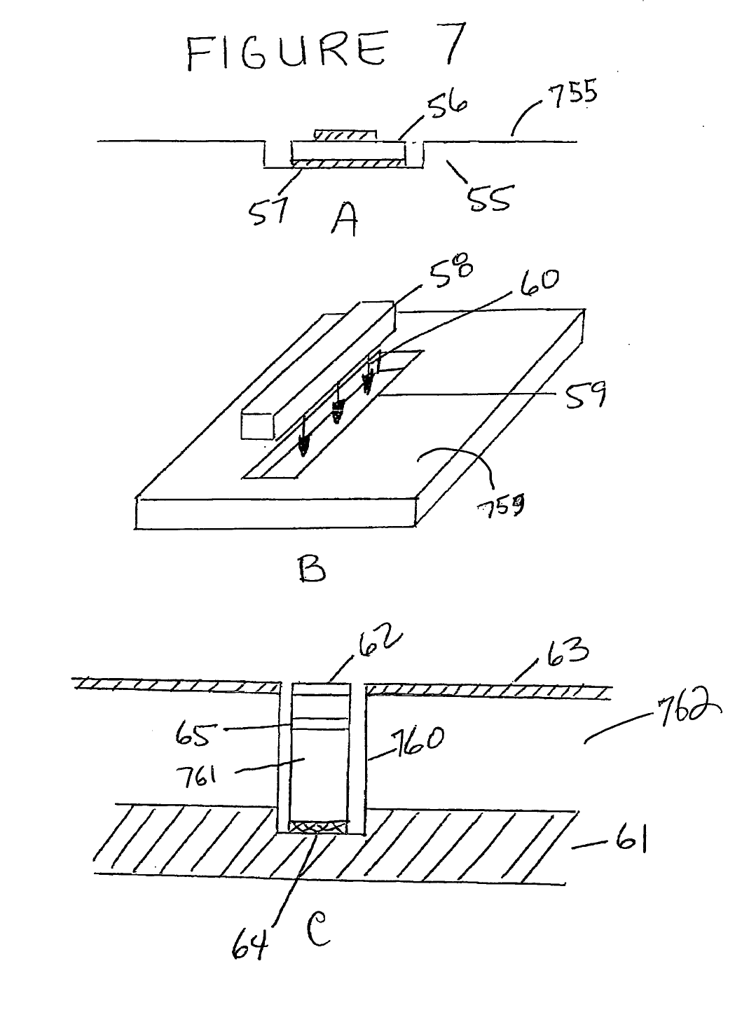

FIG. 7 depicts alignment methods for positioning epitaxial chips on a panel for interconnect. FIG. 7A depicts the positioning of vertical chip 56 in pocket 55 on substrate or panel 755 such that contact 57 is in the bottom of pocket 55. To facilitate distribution and placement of the epichips across the display fluids, gases, mechanical vibration, magnetic attraction and wetting techniques can facilitate the positioning to vertical chip 56. Epichips can be distributed in a fluid that flows across a substrate, which have reciprocal pockets with the same aspect ratio of the epichips. The epichips quickly fill up the pockets. This is followed with fluid flow without epichips, which wash all remaining epichips, which are not in a pocket off of the substrate. The washed off chips are collected in a strainer and added to the fluent containing epichips to populate the next panel. Alternatively, sacrificial or removable layers created at the wafer level or chip level can be used to provide positioning for placement of the epichips. FIG. 7B depicts the positioning of a high aspect ratio epitaxial chip 58 into pocket 59 on substrate 759. The shape of pocket 59 may be used to facilitate positioning. Orientation of the high aspect ratio epitaxial chip 58 includes, but is not limited to, the use of surface tension, magnetic means, vibrator, mechanical flow, and mechanical means insertion 60 onto the pocket 59 in the panel. Alternately anti-parallel sides and or interconnects, can be used to remove the need for orientation in one axis. Epichips with side electrodes, as previously discussed, facilitate positioning, testing and repair. Trapezoidal or triangular epichips used with reciprocal pockets can also be used to align epichips that have electrodes on one face (flipchip) or have side electrodes or contacts. FIG. 7C depicts a high aspect ratio epichip 761 with top contact 62 and bottom contact 64 and pn junction 65, which has settled into a reciprocal pocket 760 on the display panel or substrate 762. Transparent contacts (ZnO, ITO, fine metal mesh, etc.) form connections to the top 63 and bottom 61 of the panel and epichip.

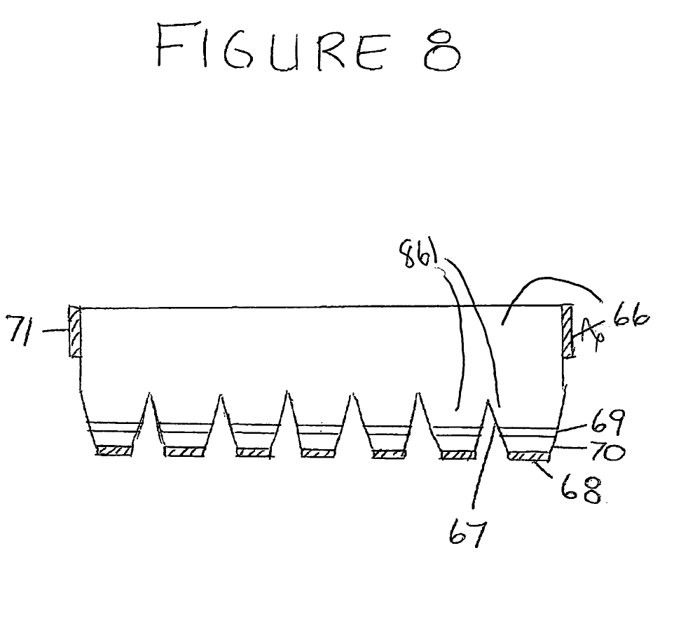

FIG. 8 depicts a macro epitaxial chip into which integrated optical elements are formed. As an example, the thick n layer 66, active region 69, and p layer 70 form a light emitting diode. The thickness of the three layers is sufficient to form a freestanding layer and sufficiently mechanically robust enough to allow the formation of trenches 67 at least partial through the layers. In the example, the trenches 67 are tapered and close enough that a compound parabolic collector (CPC) shape is formed. The inclusion of reflective contact 68 controls the direction of light out of the individual elements formed. N contact 71 can be either within the trenches 67 or around the periphery of the macro epitaxial chip. In this manner, an array of highly directional light emitting diodes can be formed within the macro epitaxial chip. The free standing nature of the macro epitaxial chip enables improved optical properties and allows for further elements such a wavelength conversion chips to be added with minimal optical crosstalk between segments.

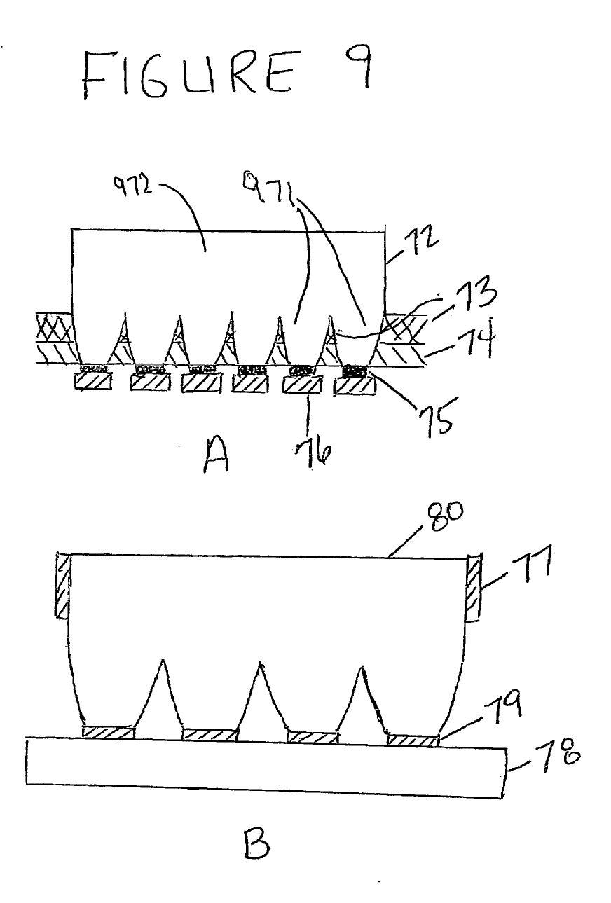

FIG. 9A depicts a macro epitaxial chip 972 with at least one integrated optical element (CPC) 971. A black matrix enhances isolation. The black matrix 73 may be totally absorptive or be formed by metalizing at least a portion of the integrated optical feature 971. A conductive material or means provides electrical contact to at least one side of the macro epitaxial chip 72. Isolation layer 74 may be added to serve as isolation for subsequent interconnect means 76 to allow for contact to individual element contacts 75. The isolation layer 74 as a planarization layer enables subsequent growth, deposition, patterning, or other means to form active or passive devices directly on the macro epitaxial chip 72. FIG. 9B depicts an alternate interconnect means whereby an external interconnect 78 is attached to individual element contacts 79 by, but not limited to, solder bump, ultrasonic welding, laser welding, or conductive adhesive bonding. Interconnect to the other side of the macro epitaxial chip 80 may alternately be by side contact 77. Combinations of interconnect means used in both FIGS. 9A and 9B are embodiments of this invention. The configurations shown in FIG. 8 and FIG. 9 provide a means of forming a microdisplay on the Epichip itself as each element is optically separate and can be uniquely electrically. These macro epichips can be microdisplays themselves or be arrayed into a larger display.

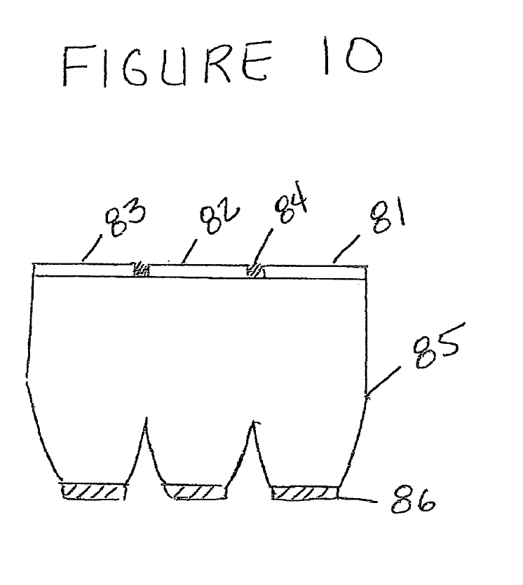

FIG. 10 depicts macro epitaxial chip 85 with external optical elements 81, 82, and 83. Due to the collimated nature of the light emitted by the integrated optical element created in the chip, a variety of optical features or elements can be created in or on the macro epitaxial chip 85. These are, but not limited to, optical elements directly created in the surface or bulk of macro epitaxial chip 85. These elements may be formed by, but not limited to, laser etching, photochemical etching, and mechanical means. These elements may function as turning elements to create off axis light emission, as photonic structures to create directivity, and/or as mixing elements to blend output from a group of individual optical elements within a macro epitaxial chip 85. In combination or separately, external optical elements 81, 82, and 83 may be used to direct, convert, collimate, or diffuse the output of the individual optical elements. Optical elements 81, 82, and 83 can be color conversion means to form an individual RGB or combined RGB structure via phosphors, quantum dots, isolated ions, or other conversion means. Directive elements including, but not limited to, photonic crystals, dichroic layers, non-imaging elements, resonant structures can be used around, within, or adjacent to at least one of optical elements 81, 82, and 83. The intention being, but not limited to, the use of these elements to form at least one partially directive output for enhanced optical throughput into a projector. Either separately or in combination, polarization means either absorptive or reflective modify the polarization or define the polarization of at least one of the individual optical elements. Any or all of these elements may form 2-D or 3-D outputs for displays either via color or polarization methods, or a combination of both. In particular, the use of the close proximity created by the elimination of the sapphire submount eliminates Fresnel interfaces and allows for reduced cross talk between individual optical elements. Contact 86 may alternately be highly reflective to enable optical recycling approaches while still maintaining significant isolation between individual optical elements. The optional use of black matrix 84 enhances contrast and/or allows for interconnect.

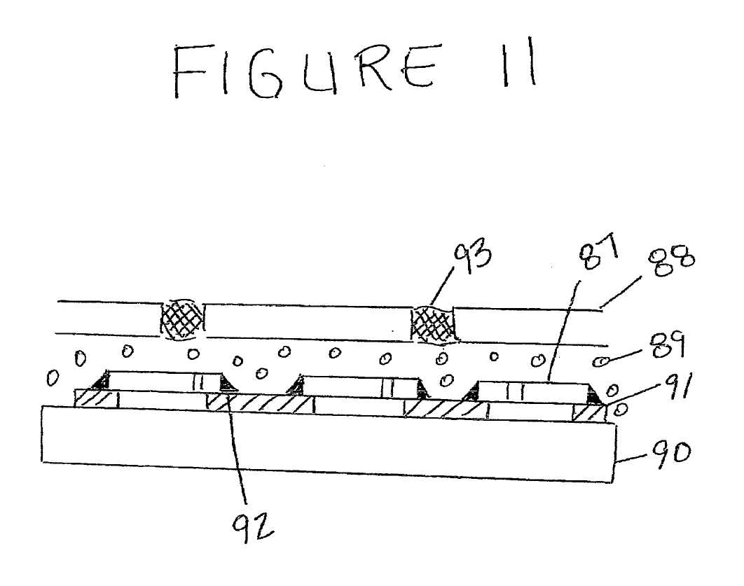

FIG. 11 depicts an assemblage of horizontally mounted epitaxial chips 87 mounted onto an interconnect substrate 90 containing addressing means 91. Addressing means 91 may include, but are not limited, to active addressing, passive addressing, active matrix addressing, or fixed regions of interconnect. An x-y grid of crossed electrodes may be used for addressing individual LED pixels. The formation of a testable, repairable, and/or modifiable array of addressed epitaxial chips is a preferred embodiment of this invention. In this manner, the need for a top electrode is eliminated making access, test, repair, and overall modification possible. Laser trimming and other modification means change uniformity of individual horizontally mounted epitaxial chips either subsequent to or during excitation. Contact means 92 may include, but are not limited to, solder, conductive epoxy, and welds. The use of eutectic solders is a preferred embodiment for contact means 92. The process involves forming the array of horizontally mounted epitaxial chips 87 on addressing means 91 on interconnect substrate 90, modifying individual horizontally mounted epitaxial chips 87, and then mounting optical elements 88 via encapsulant 89. Optical elements 88 may be formed as free standing elements or deposited onto the array. Optical elements 88 may include, but are not limited to, wavelength conversion elements, microoptical elements, polarization defining elements, and diffusing elements. Combinations of these elements either within a single element or via stacking are an embodiment of this invention. Encapsulant 89 may be organic or inorganic and may include, but is not limited to, epoxies, thermoplastics, sol-gels, and glasses. Due to the high temperature processing capability of the freestanding epilayer LEDs inorganic glasses have been successfully used to encapsulate the LEDs. An additional black matrix 93 enhances contrast of the array. The directional elements within optical elements 88 including, but not limited to, non-imaging elements, lens, photonic crystals, dichroics and micro optics controls output distribution of the array. This directivity creates enhanced viewing in high ambient lighting conditions. The directivity, polarization, and/or color enables 3-dimensional displays to be formed.

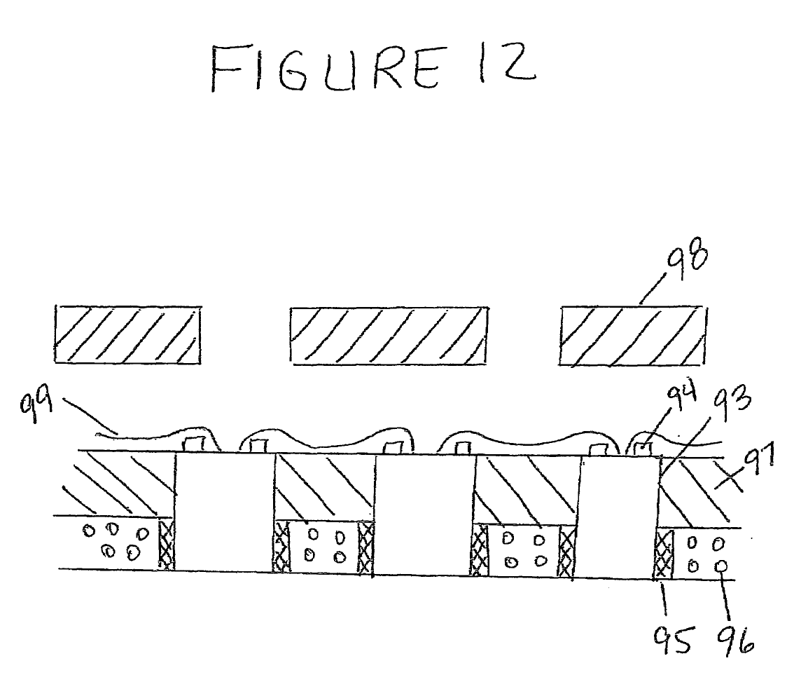

FIG. 12 depicts an assemblage of epitaxial chips 93 formed into a sheet by matrix 97. Addressing elements 94 may be formed on the epitaxial chips 93 at the wafer or segmented level by organic and/or inorganic means as known in the art. The use of inorganic semiconductor processing is most preferred for reduction in device size, uniformity, and performance is preferred. The formation of these addressing elements 94, after formation of the sheet, uses a high temperature matrix 97 such as, but not limited to, glass, ceramic, epoxy, or metal matrix. The use of bottom contact 95 and electrode 96 forms a common or array of interconnection for the epitaxial chips 93. A preferred embodiment of this invention is the use of a dielectric material for matrix 97. Even more preferred is the use of a matrix 97 that enhances contrast by absorption. The formation of addressing electrodes 99 provides interconnect between addressing elements 94. More specifically the formation of gate, data, positive electrode line, and negative electrode line, as depicted in FIG. 6, uses addressing electrodes 99 and electrode 96 to form an actively addressed array of epitaxial chips 93. Electrodes 99 may be an x row and 96 a y row perpendicular to electrodes 99. The use of alternate addressing architectures is an embodiment of this invention. The output of the epitaxial chips 93 can be converted by wavelength converting means 98. (For example: phosphors or wavelength conversion chips as described in U.S. Pat. No. 7,285,791.) The use of RGB elements to create a flat panel display is a preferred embodiment of this invention for vertically, horizontally, and/or oblique mounted epitaxial chips.

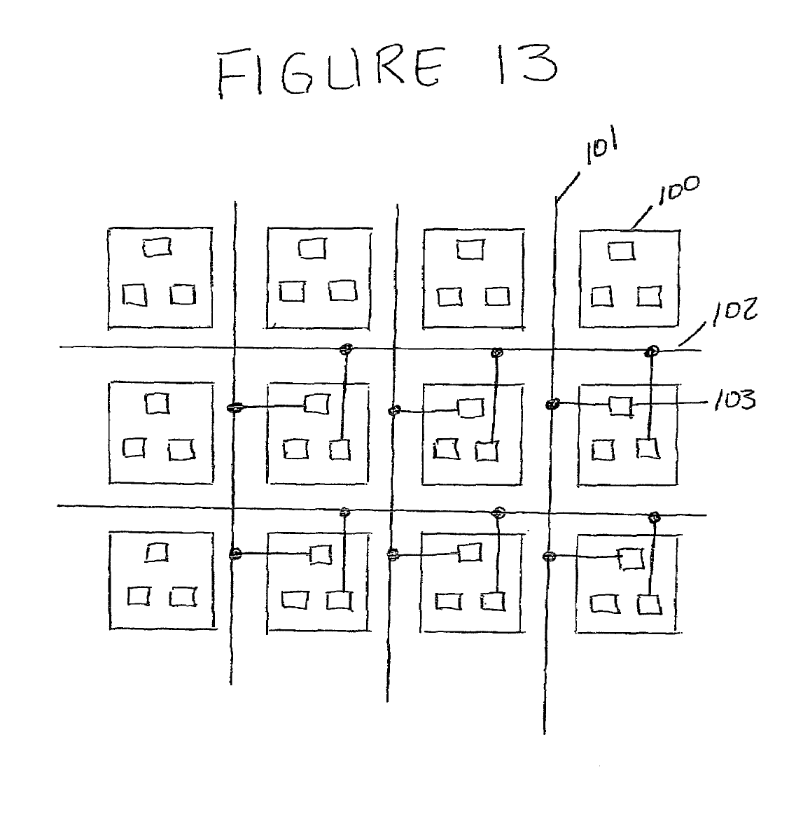

FIG. 13 depicts a typical actively addressed interconnect. Epitaxial chips 100 are arrayed and contain active addressing elements 103. Interconnect to active addressing elements 103 via x and y data lines 101 and 102 are depicted schematically. The use of printing conductive interconnect techniques to form data lines 101 and 102 are preferred embodiments. In addition the interconnects to the epichips may be done by printing transparent conductive traces to the datalines. One process for forming such traces is described in U.S. Provisional Patent Application Ser. No. 61/271,503, commonly assigned as the present application and incorporated herein by reference. In the aforementioned application, it is shown how metal mesh traces may be formed on freestanding LED chips. These traces may also be formed on transparent glass panels to connect to the deposited data lines interconnecting to the discrete epichips or macro epichips forming the display.

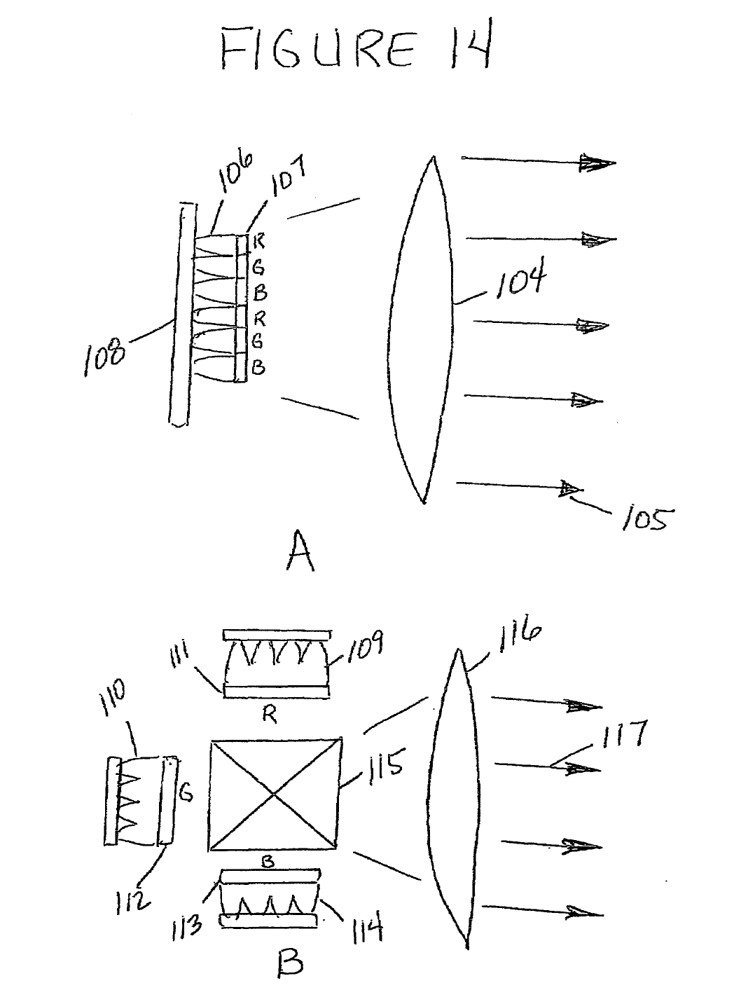

FIG. 14A depicts a single macro epitaxial chip 106 containing integrated optical elements and RGB luminescent elements 107. Addressing of the individual elements of macro epitaxial chip 106 is by an active backplane 108. The active addressing is integrated onto macro epitaxial chip 106 as discussed earlier. An image 105 is formed at a distance via lens 104. The use of this approach to make a projector is an embodiment of this invention. This forms an elegantly simple projector, which can be made very small and used in an embedded application like a cell phone. The use of this approach to make any imaging system is an embodiment of this invention. Single color micro epichip arrays may also be used to form higher intensity projectors by combining colors as known in the art. FIG. 14B depicts the use of color combining means 115 which may consist of, but are not limited to, an X cube, dichroic filters, and polarization combiners. In this configuration, macro epitaxial chips 109, 110, and 114 emit in different wavelength ranges and/or polarization states such that their outputs can be combined without a significant increase in etendue for the system. The wavelength conversion elements 111, 112, and 113 convert the wavelength of the macro epitaxial chips 109, 110, and/or 114 to a different range of wavelengths. The lens 116 form an image at a distance 117. Lens 116 may include, but are not limited to, refractive, diffractive, and reflective optics.

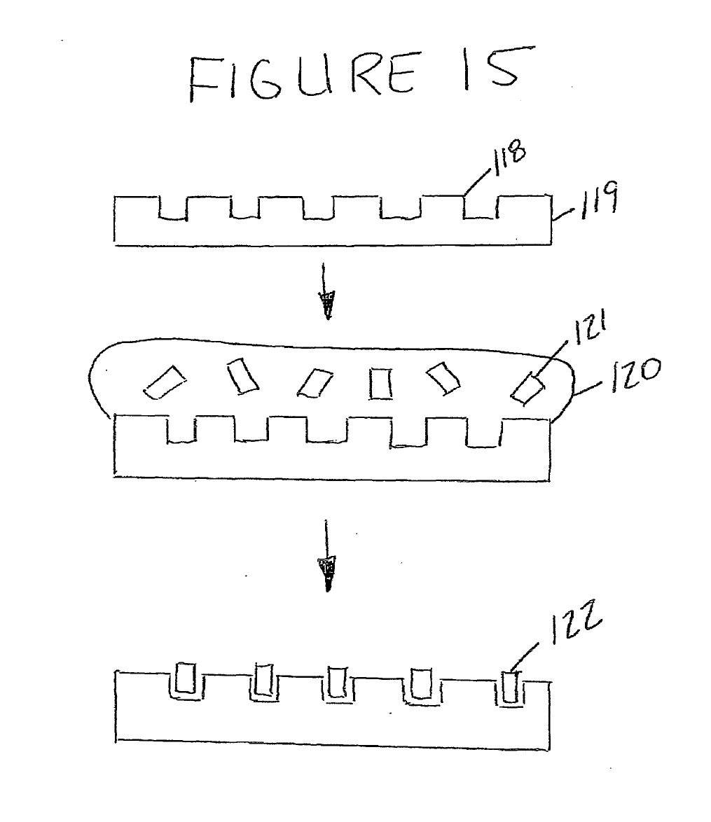

FIG. 15 depicts a process for locating epitaxial chips 121 onto a substrate 119 by forming alignment features 118 within the substrate 119. The suspension media 120 (fluid, gas, etc.) allows the epitaxial chips 121 to locate into the alignment features 118. The use of magnetic, vibration, surface tension, drying, centrifugal and electrostatic forces induces the epitaxial chips 121 into the alignment features 118. The oriented epitaxial chip 122 may also exhibit asymmetry by, but not limited to, its shape, solderability, surface energy, or density such that one side orients more easily into the alignment feature 118. The alignment features may have reciprocal features symmetrically opposite (e.g. male/female) the epitaxial chip shape to align the chips in the proper orientation for interconnect. This approach forms large distributed arrays of LEDs for lighting, backlighting, signage, and displays as an embodiment of this invention.

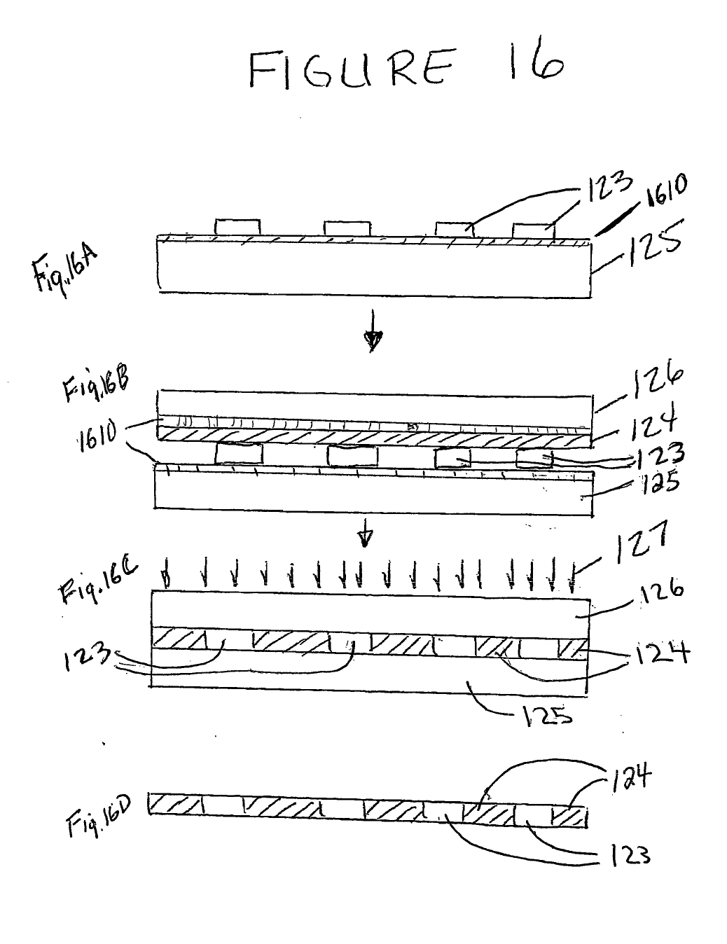

FIG. 16 depicts a process for forming a sheet of epitaxial chips 123 which may be mounted vertically, horizontally, or obliquely. In FIG. 16A the epitaxial chips 123 are placed or mounted onto temporary support 125. Temporary support 125 may consist of, but is not limited to, glass, metal, or polymer with sufficient integrity to support the epitaxial chips 123 during the process. In FIG. 16B release layers, adhesive layers 1610 and dissolving methods are used to hold, then later release, or remove temporary support 125 and press plate 126. Matrix layer 124 is positioned between temporary support 125 with epitaxial chips 123 and press plate 126. In FIG. 16C pressing means 127 may include, but are not limited to, heat, pressure, actinic radiation, and vibration such that matrix 124 substantially moves and fills in around epitaxial chips 123 such that epitaxial chips 123 form stops against which temporary substrate 125 and press plate 126 are held apart. After matrix material 124 cools, sets, or cures the temporary substrate 125 and press plate 126 are removed by, but not limited to, mechanical means, dissolution, laser liftoff, and thermal expansion means. The resulting article FIG. 16D consisting of just the epitaxial chips and the matrix material formed by this process is an embodiment of this invention. The matrix material may consist of glass, metal, polymer, etc to either isolate or connect the epichips into a addressable display. The matrix material may be slightly etched by solvent before it is fully cured to remove any residual matrix material left by the pressing process on the top and bottom of the epichips. Transparent electrically conductive interconnects may be printed, plated or otherwise deposited on the top and bottom of the finished sheet to form an addressable display.

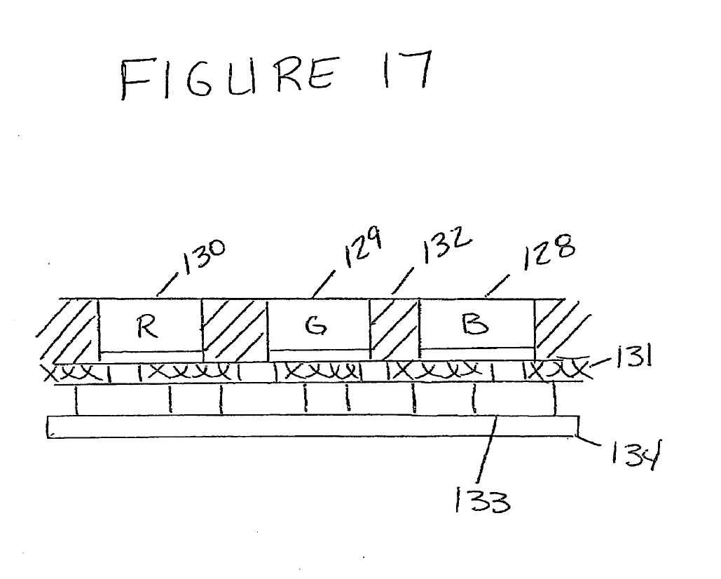

FIG. 17 depicts a sheet of epitaxial chips 131 formed by this process to which luminescent elements 128, 129, and 130 are attached along with black matrix 132. A two layer grid addressing means 133 and interconnect means 134 are mounted to the epitaxial chips on the opposite side of the epitaxial sheet of epichips away from the luminescent elements. The formation of a display, sign, or light source based on this article is an embodiment of this invention.

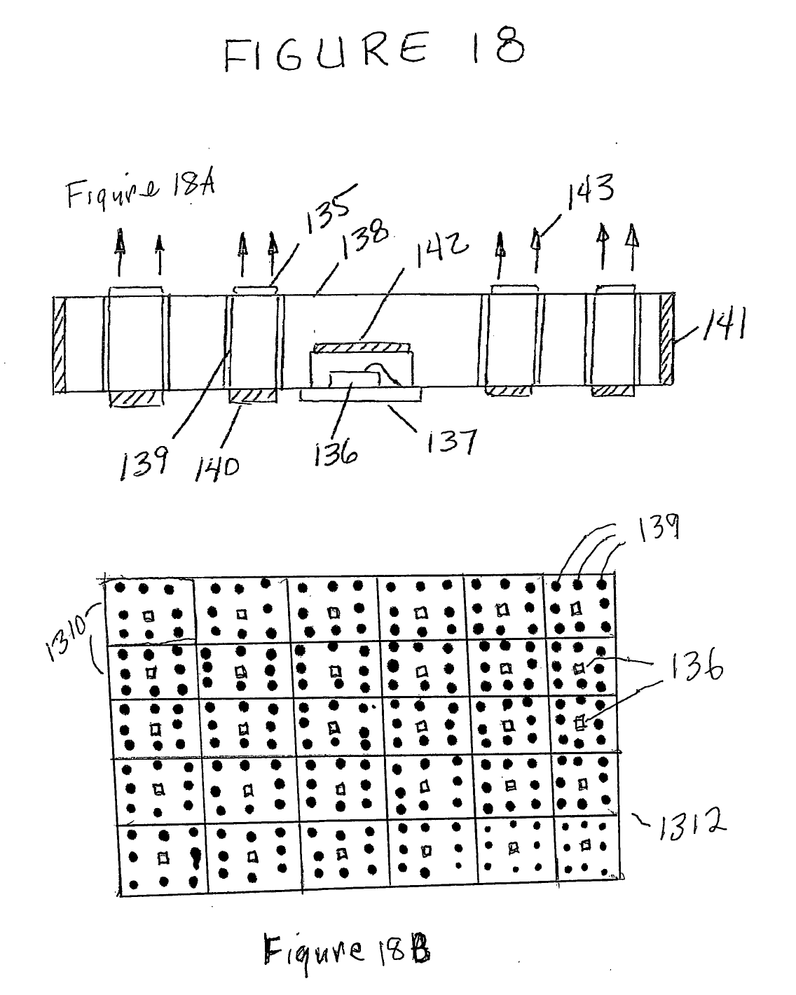

FIG. 18A depicts yet another method of forming an addressable display by forming an assemblage of light extraction elements 139 which are illuminated via a waveguide 138 by a excitation source 136. The excitation source is at least one LED. The excitation source 136 is cooled via heatsink 137. The invention creates an array of directional emitters within the area of the waveguide 138. The rear reflector 140 directs substantially all the light extracted/generated by light extraction element 139 through reflective polarization element 135. This assembly can be used in 2D dimming applications for LCD displays. The waveguide of excitation source 136 can be coupled based on forming a cavity in the waveguide by using highly reflective elements for the excitation source 136, top surface of heatsink 137 and top reflector 142. Light extraction element may be, but are not limited to diffuse, substantially clear, birefringent, layered, and shaped to enhance extraction in the direction and/or polarization of the emission 143. Wire grid, photonic structures, and DBEF materials can create reflective polarization element 135. Light extraction element may also consist of wavelength conversion materials such that RGB spectral emission from the LED source. In U.S. Pat. No. 7,285,791, commonly assigned as the present application and herein incorporated by reference, a means of forming wavelength conversion chips for use with LEDs is shown. A blue excitation source 136 and at least one light extraction element 139 can scatter some of the blue light and convert the rest of the blue light into other spectral ranges of other colored light as desired. The additional excitation sources 136 with fixed or adjustable outputs can create, balance, and otherwise control the spectral and intensity characteristics of the emission 143. The end reflectors 141 can control mixing within the waveguide 138. Partial reflectors 141 determine coupling between adjacent waveguides when they are arrayed in arrays of blocks. In the example shown, the light extraction elements 139 are not index matched to the waveguide such that excess light, which is not in the direction of emission 143, recouples into the waveguide 138 to be extracted at another location within the device. The thickness and size of waveguide 138 and the number and size of light extraction elements 139 are critical factors in determining uniformity and extraction efficiency. The thickness of preferred waveguide 138 is less than 1 mm. In FIG. 18B a plan view of a large area display 1312 is which may be formed by arranging the waveguides into an array of blocks 1310. The size of these blocks 1310 and the number and distribution of extraction elements 139 may be adjusted to fit the desired size and brightness of the display. Each of the blocks has at least one LED 136 to excite or couple to the extraction elements 139. Each LED may be individually addressed by an xy grid of interconnects that are thin and don't block the light emanating from the extraction elements. In this manner a large area display may be formed. Alternatively, a backlight for a conventional LCD flat panel display may be formed which permits local dimming to enhance the contrast of the display. Using this technique saves cost in that the extraction elements are much less expensive than arrays of LEDs used for localized dimming LCD displays. The use of low absorption materials for both the light source and wavelength conversion layer is also a critical factor in determining uniformity and efficiency of this approach. The use of low loss materials for the waveguide, both organic and inorganic, is an embodiment of this invention. Most preferably the use of acrylics or Zeonex materials as low absorption materials is an embodiment of this invention.

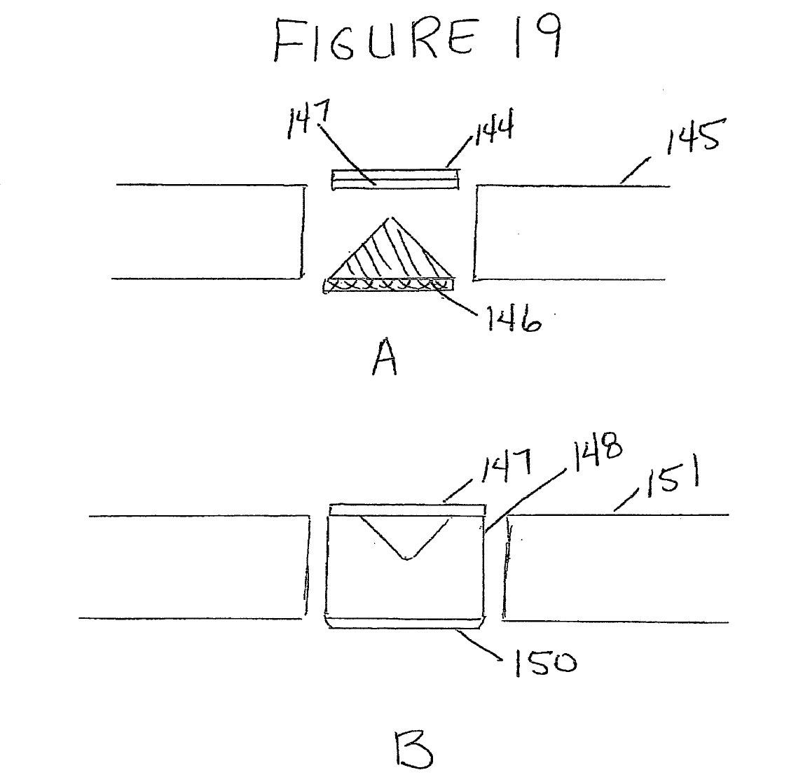

FIG. 19A depicts another means of forming light extraction elements within the waveguide 145. A turning element 146 may consist of, but is not limited to, spectral or diffuse reflector. Though the extraction element is shown all the way through the waveguide 145, the light extraction elements can be formed only part way through the waveguide 145. The critical requirement is that substantially all the excess light not emitted through wavelength conversion or directional element 147 and polarization element 144 is recoupled back into waveguide 145. In FIG. 19B, the shaping of the light extraction element 148 to preferentially direct light into a forward direction is shown. Rear reflector 150 and polarization element 149 determine direction and polarization state emitted by the light extraction element 148 with the excess light recoupling back into waveguide 151, where it will have an additional opportunity to be extracted. The combination of scattering and wavelength conversion within light extraction element 148 creates a desired spectral output.

A color stable LED display may be formed by utilizing the wavelength conversion material methods described in U.S. Provisional Patent Application Ser. No. 61/189,652 and incorporated herein by reference. Combining these techniques with those described in detail above a large area backlight or addressable LED display may be formed which has very good color stability (tolerant to ambient temperature extremes).

An embodiment of the invention and a preferred embodiment is an LED visual display utilizing freestanding epitaxial chips. One can create an addressable LED display by using two panels with a grid of conductive electrodes such that the two grids are crossed. The epitaxial chips can be dispersed between two panels wherein a grid of conductive electrodes makes contact to each side of the epitaxial chips. The grid of electrodes on one panel is crossed in relationship to the grid on the opposite panel such that the panel can be XY addressed to light up individual pixels (epitaxial chips) adjacent to the electrodes that are energized. This would create a monochromatic LED display and since the display does not require a light valve (e.g. Liquid crystal) the display would be much brighter than a corresponding LCD display.

A full color panel can be constructed utilizing thin layers of wavelength conversion materials that are patterned onto the electrodes on the two sandwiching glass or plastic panels. More preferably and keeping within the low cost nature of the epitaxial chip, the wavelength conversion material and the electrodes could be formed within plastic. The unique feature of these epitaxial chips is that they are not subject to degradation from moisture, therefore can be encapsulated in plastic. Current organic light emitting diode displays must be encapsulated or sandwiched between glass layers to prevent moisture. More preferably, epi chips are distributed over the area of the panel utilizing an inkjet printer in which the epi chip is dispersed within a reservoir of wavelength conversion pigments in a plastic binder. Multiple colors could be easily printed for each pixel. There could be as many as five or six colors per pixel enabling a very wide gamut visual display. Since the epitaxial layer is inorganic, it is compatible with a multitude of thermoplastic pigments as used in plastic scintillators and luminescent fibers.

Another embodiment of the invention incorporates two glass or plastic panels sandwiching distribution of epilayers wherein the two panels have crossed electrodes for XY addressability but utilize transparent panels on the front and the back sides. This can make for a very unique and striking transparent visual display either for aesthetic reasons or for applications requiring the ability to see a display overlaid on a background scene or document, etc.

The epitaxial layers can be maintained in their arrayed registration contained in a gel pack or the epitaxial layer chips can be collected in a fluid, e.g. water in a container underneath the sapphire wafer. The chips are then washed in potassium hydroxide and rinsed and filtered to remove gallium and any other debris. The microchips are then transferred to a printing system and deposited onto an active matrix transparent electronic grid. This grid can be made using indium tin oxide, zinc oxide, ultra thin metal or single walled carbon nano-tubes. Luminescent polymers are printed in registration with the transparent electrode grid. These wavelength conversion pigments and black matrix are all registered and can be printed using screen printing, inkjet printing, etc.

Once the epitaxial die are deposited, solvents are evaporated and another panel with electrodes aligned 90 degrees to the base panel are brought in contact and bonded using transparent adhesives. The epitaxial die are excited via the addressable matrix of electrodes on the two panels such that red, green, or blue pixels can be turned on and off to form a visual display. Advantages of this process are that it requires simple and inexpensive processing and can be made in high volumes to produce multi-colored displays with high luminance output. There is no backlight required like with liquid crystal displays and the viewing angle can be quite wide with very high contrast. Current cost to fabricate these wafers of epitaxial die is approximately $200.00. A flat panel display with 100 million pixels made up of 10 micron epitaxial microchips would require 5 two inch wafers containing 20 million chips per wafer.

Methods are shown that incorporate several proprietary processing steps to produce free standing epi LED chips or flake LEDs (FLEDs) that do not require a substrate. These FLEDs or epi chips can be arrayed in one, two and three dimensional planes such that an emissive display is formed. Unlike other display technologies, these epi chips do not require a sealed cavity and can be matrix addressed in a number of different ways. While visible emission is possible with the epi chips, a preferred embodiment for this invention is UV emission with a peak emission wavelength less than 450 nm. In this embodiment, wavelength conversion materials are used to create the visible emission required. This embodiment eliminates the need for increased drive complexity as required when multiple emission wavelength LEDs are used. It also allows for the addition of other colors via additional luminescent materials.

Typically, over 200 mW of optical output is generated out of an 1 mm2 die with an input of 1 watt electrical in the blue. UV LEDs typically are somewhat lower. As an example, a 7 foot diagonal display (approximately 21 ft² of display area) emitting 100 ftL lambertian, approximately 2000 lumens would be emitted. This could be divided into approximately 1300 lumens green, 500 lumens red, and 200 lumens blue depending on the color point desired. This represents approximately 2 optical watts of output for each color.

Over 2 million pixels are used in high definition displays. Based on this, approximately 2 microwatts of output would be required for each epi chip. Even considering losses due to pulsed drive consideration, wavelength conversion, and packaging, an epi chip less than 25 microns by 25 microns could supply that level of output. Alternately, a typical 1 mm2 area die outputs 0.3 watts of optical power for every 1 watt of electrical input. If 25 micron×25 micron die are used approximately 1 sq inch of die area would be used based on the number of pixels required. That is equivalent to 650 1 mm2 die with a combined output of 195 optical watts given an input of 650 electrical watts. Reducing the electrical input to 65 watts would still render 19.5 optical watts of output, which is still over 3 times the total optical watts of output needed for a 7 foot diagonal display. This provides for a substantial optical margin which can be used to facilitate interconnect and wavelength conversion means.

In the case of projection displays, the epi chips are closely packed to minimize the source étendue. Optionally the use of directive optics such as microlens, microcavities, and photonic crystals on each epi chip may be used to reduce the étendue of the source further. In the case of direct view displays the epi chips are separated a sufficient distance to create the necessary finished diagonal size.

An AlGaN heterojunction or quantum well LED can fabricated via methods known in the art. In this particular structure, an active emission region emitting preferably between 200 nm and 450 nm is formed. The use of HVPE processing of the epi facilitates the formation of a thick epi with sufficient crystal quality to be separated from its' growth substrate while maintaining a low internal absorption. ODR contacts are formed on both sides of the active emission region with at least one facet having at least a partial opening to allow light to be emitted from the chip. Surface profiles are rendered in the surfaces of the epi sufficient to facilitate physical contacts. The use of magnetic layers and adhesive layers to create the necessary pressure for contact are also illustrated.

A single micro epi chip may contain a surface roughness sufficient to form electrical contacts to a metallic surface when sufficient pressure is applied.

A linear array of epi chips are bonded to a thermoplastic submount containing a series of metal lines on side of the chip and graphite sheet on the other side. The two sides are held together using two magnetic strips. The linear array is an expandable array.

Multiple linear arrays can be assembled to form a 2 dimensional display. A microlens or an array of microlenses can be attached to the linear array. An expanded linear array is suitable for use in large area flat panel displays. The expanded linear arrays can have wavelength conversion materials and black matrix materials. The linear array can be fabricated to direct the light from the LEDs in the array. The HVPE approach to LED and array fabrication provides a narrow wavelength range for the light emission from the LEDs.

Interconnect means can be provides for the LED arrays. The LEDs and the array can be shaped die. The LEDs and the array may optionally have a graphite heatsink. The LEDs and the array may use a magnetic clip and leadframe for attachment into arrays. Magnetic contacts can be used for the LEDs in the array or the LEDs can be tab bonded. Capacitive and inductive interconnect can be provided for the LEDs in the array with addressing to each pixel.

Except where noted (e.g. FIGS. 18 and 19 utilizing waveguides) a key component of the invention disclosed herein is the epitaxial chip, which is fabricated by methods developed by the inventors and referenced herein. These unique epitaxial substrate less LEDs (distinguished from conventional LEDs which typically are mounted on or consist of a non-native substrate) allow for the novel structures disclosed herein.

While the invention has been described with the inclusion of specific embodiments and examples, it is evident to those skilled in the art that many alternatives, modifications and variations will be evident in light of the foregoing descriptions. Accordingly, the invention is intended to embrace all such alternatives, modifications and variations that fall within the spirit and scope of the appended claims.

1. A display comprising
multiple epichip LEDS.

2. The display in claim 1 further comprising
addressing means to epichip LEDs to form either a monochrome or color display.

3. The display in claim 1 further comprising
optical elements formed in the epichip LEDs.

4. The display in claim 1 wherein the epichip LEDs are initially freestanding (not attached to a non-native substrate prior to being mounted to form the display) and are at least 10 micrometers thick.

5. The display in claim 1 wherein the epichips are fabricated by forming LEDs on thin 10 to 100 micrometer nitride foils.

6. A display comprising
multiple epichip LEDs or a single macro epichip LED; and
means for interconnecting and addressing the individual emissive elements to form a one or two dimensional display.

7. The display in claim 6 wherein the epichip LEDs are transparent and emit on opposite sides to form a transparent display which emits from both sides.

8. An addressable LED display or backlight comprising
an LED;
a waveguide; and
light extraction elements.

9. The LED display or backlight in claim 8 wherein the light extraction elements consist of wavelength conversion chips arrayed and embedded in the waveguide and surround the addressable LED.

10. A display comprising
epichip LEDS;
an addressable backplane or xy grid; and
wherein the epichip LEDs are arrayed on the backplane and form a two dimensional display.

11. The display in claim 10 where the epichips are dispersed onto the addressable backplane via a fluid or gas or printed via inkjet.
